(19) United States
(12) Patent Application Publication
(10) Pub. No.: US 2023/0007017 A1
(43) Pub. Date: Jan. 5, 2023

(54) ENFORCING JAVASCRIPT FOR MITB DETECTION

(71) Applicant: Fortinet, Inc., Sunnyvale, CA (US)

(72) Inventor: Radhesh Ramakant Walwadkar, Pune (IN)

(21) Appl. No.: 17/364,691

(22) Filed: Jun. 30, 2021

(51) Int. Cl. H04L 29/06; H04W 12/128

(52) U.S. Cl. CPC H04L 63/1416; H04W 12/128

(57) ABSTRACT

A request for a confidential web page, and in response, can transmit an HTML code snippet to a browser running on a network device coupled to the data communication network to determine whether JavaScript is enabled locally at the network device. The confidential web page can be, for example, a log in, or other sensitive or personal data, vulnerable to browser-based intrusions. Responsive to detecting that JavaScript has been disabled, restricts subsequent communication by the network device, wherein the application firewall requires enabling of JavaScript to continue to the confidential web page. On the other hand, responsive to detecting that JavaScript has not been disabled, allowing the request for the confidential web page to proceed.

### FIELD OF THE INVENTION

The invention relates generally to computer networking, and more specifically, for detecting security breaches from web-based applications through JavaScript security.

### BACKGROUND

MITB or Man-in-the-Browser is an advanced client-side attack targeted at capturing sensitive data credentials. It is achieved by inserting a client side browser extension which has visibility on all the network traffic that is passing between a user and a confidential web site. When a user launches a browser, malicious browser extension code is also launched.

Traditionally, WAF vendors rely upon JavaScript to encrypt or otherwise obfuscate data. But JavaScript can be turned off on the browser on purpose or unintentionally, leaving the computer device vulnerable for MITB attacks.

Therefore, what is needed is a robust technique for detecting security breaches from web-based applications through JavaScript security.

### SUMMARY

These shortcomings are addressed by the present disclosure of methods, computer program products, and systems for detecting security breaches from web-based applications through JavaScript security.

In one embodiment, a JavaScript detection module detects a request for a confidential web page, and in response, can transmit an HTML code snippet to a browser running on a network device coupled to the data communication network to determine whether JavaScript is enabled locally at the network device. The confidential web page can be, for example, a log in, or other sensitive or personal data, vulnerable to browser-based intrusions.

In another embodiment, a JavaScript restriction module, responsive to detecting that JavaScript has been disabled, restricts subsequent communication by the network device, wherein the application firewall requires enabling of JavaScript to continue to the confidential web page. On the other hand, responsive to detecting that JavaScript has not been disabled, allowing the request for the confidential web page to proceed.

Advantageously, computer hardware and network operations are improved by preventing man-in-the-middle attacks.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level illustration of a system for detecting security breaches from web-based applications through JavaScript security, according to an embodiment.

FIG. 2 is a more detailed illustration of a gateway device of the system of FIG. 1, according to an embodiment.

FIG. 3 is a more detailed illustration of a JavaScript security module of FIG. 2, according to some embodiments.

FIG. 4 is a high-level flow diagram illustrating a method for detecting security breaches from web-based applications through JavaScript security, according to one preferred embodiment.

FIG. 5 is a more detailed flow diagram illustrating the step of automatically configuring link aggregation of incompatible data ports for the method of FIG. 4, according to one embodiment.

FIG. 6 is an example of a computing environment, according to an embodiment.

### DETAILED DESCRIPTION

The description below provides methods, computer program products, and systems for detecting security breaches from web-based applications through JavaScript security. One of ordinary skill in the art will recognize many additional variations made possible by the succinct description of techniques below.

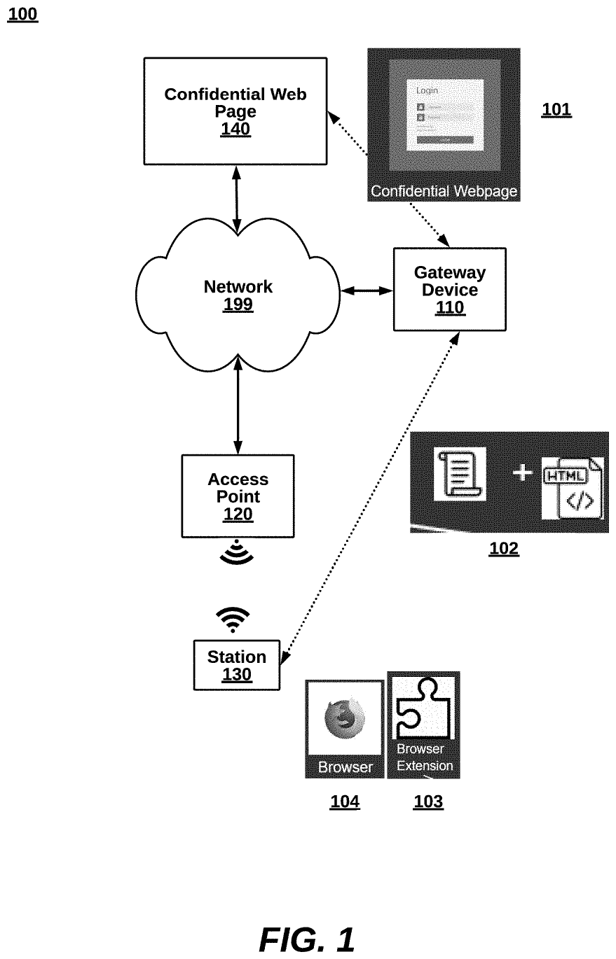

I. Systems for Detecting JavaScript Security Breaches (FIGS. 1-3)

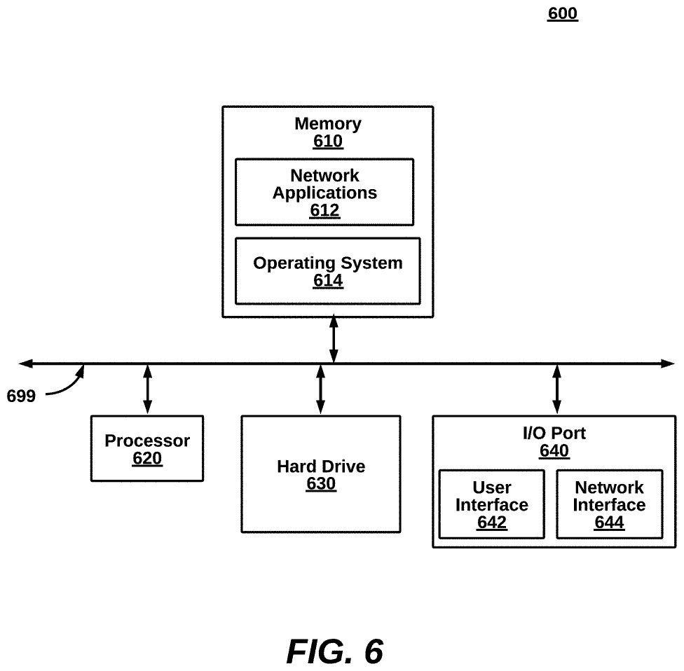

FIG. 1 is a high-level illustration of a system 100 for detecting security breaches from web-based applications through JavaScript security, according to an embodiment. The system 100 includes a gateway device 110, an access point 120 and a station 130. Many other embodiments are possible, for example, more or fewer access points, more or fewer stations, and additional components, such as firewalls, routers and switches. The system 100 components can be located locally on a LAN or include remote cloud-based devices, and can be implemented in hardware, software, or a combination similar to the example of FIG. 6.

The components of the system 100 are coupled in communication over a network 199. Preferably, the gateway device 110, and the access point 132 are connected to the data communication system via hard wire. Other components, such as the station 130 are connected indirectly via wireless connection. The network 199 can be a data communication network such as the Internet, a WAN, a LAN, WLAN, a cellular network (e.g., 3G, 4G, 5G or 6G), or a hybrid of different types of networks. Various data protocols can dictate format for the data packets.

In one embodiment, the gateway device 110 monitors traffic for, among other things, requests for confidential web pages 101. The confidential web page can be a login to a bank account online, a login to a social media platform, or many other variations as needed for a particular implementation. Prior to, or in the process of returning results of the confidential web page, the gateway device 110 checks for JavaScript enablement at the station 130 running a browser 104. If JavaScript is disabled, no further communications are permitted until verification that JavaScript has been enabled. In one embodiment, an HTML snippet is sent with JavaScript 102.

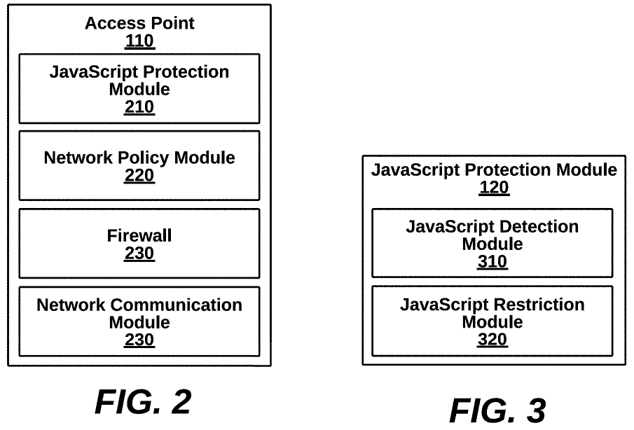

In other operations, the gateway device 110 can perform firewall duties to protect an enterprise network from external and internal threats (e.g., data packets flowing in and out and viruses running on internal devices). The gateway device 110 can be the FORTIgate device described below, implemented as a single device (see e.g., FIG. 6), as multiple cooperating devices, or as a virtual device. Additional embodiments of the gateway device 110 are shown below with respect to FIG. 2.

The access point 120 can also implement the disabled JavaScript vulnerability protections described herein. In some embodiments, the access point 120 cooperates with the gateway device 110 for protection.

The station 130 can be a mobile client, for instance, a smartphone, a tablet computer, or a smart appliance. The station 130 includes a processor that can be executing the web browser 104 or other web app, with a MITB browser extension 103, seeking Internet access. The station 130 includes NIC with a unique MAC.

FIG. 2 is a more detailed illustration of the gateway device 110 of the system 100 of FIG. 1. The gateway device 110 includes a JavaScript protection module 210, a network policy module 220, a firewall 230, and a network communication module 240. The modules can be implemented in source code stored in non-transitory memory executed by a processor. Alternatively, the modules can be implemented in hardware with microcode. The modules can be singular or representative of functionality spread over multiple components.

An embodiment of the JavaScript protection module 210 is illustrated in FIG. 5, with more detail.

A JavaScript detection module 310, in an embodiment, detects a request for a confidential web page. In response, an HTML code snippet are transmitted to a browser running on a network device coupled to the data communication network to determine whether JavaScript is running locally at the network device.

The JavaScript restriction module 320, responsive to detecting that JavaScript has been disabled, can restrict subsequent communication by the network device. The application firewall requires enabling of JavaScript to continue to the confidential web page. Responsive to detecting that JavaScript has not been disabled, the request for the confidential web page is allowed to proceed. In some embodiments, JavaScript state will be checked again after a certain duration of time, or other trigger.

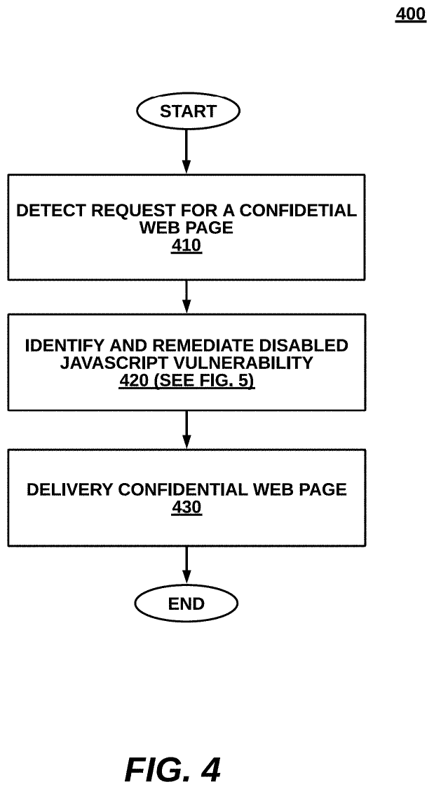

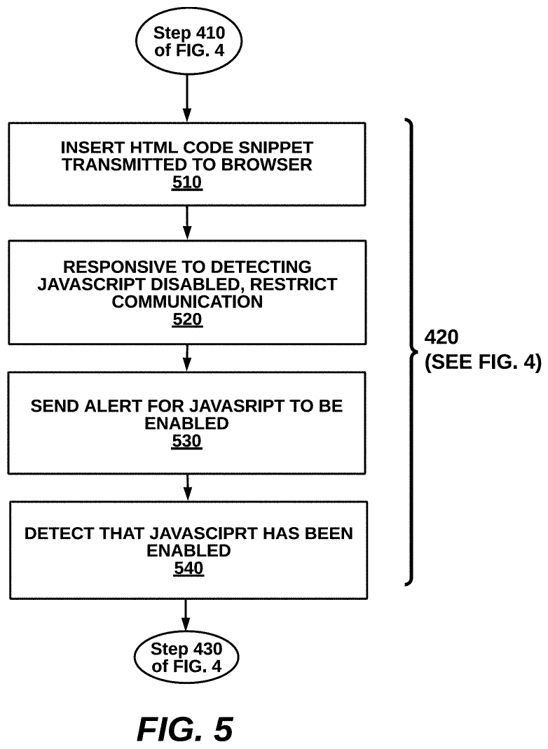

II. Methods for Detecting JavaScript Security Breaches (FIGS. 4-5)

FIG. 4 is a high-level flow diagram illustrating a method for detecting security breaches from web-based applications through JavaScript security, according to one embodiment. The method 400 can be implemented, for example, by the system 100 of FIG. 1. The steps are merely representative groupings of functionality, as there can be more or fewer steps, and the steps can be performed in different orders. Many other variations of the method 400 are possible.

At step 410, a request for a confidential web page is detected by an access point, gateway, or other firewall device. For example, a URL can be known for accessing sensitive data (e.g., www.chase.com). At step 420, a disabled JavaScript vulnerability is identified and remediated, as described in more detail below. At step 430, once remediated, confidential web pages can be delivered.

An example of the disabled JavaScript vulnerability identification step 420 is shown in FIG. 5. At step 510, an HTML code snippet is transmitted to a browser running on a network device coupled to the data communication network to determine whether JavaScript is running locally at the network device. At step 520, a JavaScript restriction module, responsive to detecting that JavaScript has been disabled, restricts subsequent communication by the network device. At step 530, an alert is sent for JavaScript to be enabled, either manually by a user of a station or automatically by a process on the station. At step 540, the application firewall requires enabling of JavaScript to continue to the confidential web page, and responsive to detecting that JavaScript has not been disabled, the request for the confidential web page is allowed to proceed.

III. Generic Computing Device (FIG. 6)

FIG. 6 is a block diagram illustrating an example computing device 600 for use in the system 100 of FIG. 1, according to one embodiment. The computing device 600 is implementable for each of the components of the system 100, such as, the gateway device 110, the access point 120 and the station 130. The computing device 600 can be a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device.

The computing device 600, of the present embodiment, includes a memory 610, a processor 620, a storage drive 630, and an I/O port 640. Each of the components is coupled for electronic communication via a bus 699. Communication can be digital and/or analog and use any suitable protocol.

The memory 610 further comprises network applications 612 and an operating system 614. The network applications 612 can include a web browser, a mobile application, an application that uses networking, a remote application executing locally, a network protocol application, a network management application, a network routing application, or the like.

The operating system 614 can be one of the Microsoft Windows® family of operating systems (e.g., Windows 96, 98, Me, Windows NT, Windows 2000, Windows XP, Windows XP x64 Edition, Windows Vista, Windows CE, Windows Mobile, Windows 6 or Windows 8), Linux, HP-UX, UNIX, Sun OS, Solaris, Mac OS X, Alpha OS, AIX, IRIX32, IRIX64, or Android. Other operating systems may be used. Microsoft Windows is a trademark of Microsoft Corporation.

The processor 620 can be a network processor (e.g., optimized for IEEE 802.11, IEEE 802.11AC or IEEE 802.11AX), a general-purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the storage drive 630.

The storage drive 630 can be any non-volatile type of storage such as a magnetic disc, EEPROM (electronically erasable programmable read-only memory), Flash, or the like. The storage drive 630 stores code and data for applications.

The I/O port 640 further comprises a user interface 642 and a network interface 644. The user interface 642 can output to a display device and receive input from, for example, a keyboard. The network interface 644 (e.g., an RF antennae) connects to a medium such as Ethernet or Wi-Fi for data input and output.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems). Some embodiments can be implemented with artificial intelligence.

Furthermore, the computer that is running the previously mentioned computer software may be connected to a network and may interface with other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase “network device” or “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

I claim:

1. An network device on an enterprise network that connects with a plurality of stations over a Wi-Fi network for data transfers, for detecting security breaches from web-based applications through JavaScript security, the access point comprising:
a processor;
a network interface communicatively coupled to the processor and to the enterprise network and to the Wi-Fi network; and
a memory, storing:
a JavaScript detection module to detect a request for a confidential web page on a specific network device, and in response, transmit an HTML code snippet to a browser running on the network device to determine whether JavaScript is enabled or disabled locally at the network device; and
a JavaScript restriction module to, responsive to detecting that JavaScript has been locally disabled, restrict subsequent communication by the specific network device,
wherein the JavaScript restriction module requires enabling of JavaScript to continue to the confidential web page, and responsive to detecting that JavaScript has not been disabled, allowing the request for the confidential web page to proceed.

2. The network device of claim 1, further comprising wherein JavaScript is transmitted to the browser of the specific network device based on the confidential web page.

3. The network device of claim 1, further comprising:
a JavaScript enablement module sends an alert message to the specific network device requesting enablement of JavaScript, prior to allowing access to the confidential web page.

4. The network device of claim 3, wherein the JavaScript enablement module receives an indication that JavaScript has been enabled, and in response, transmits a second HTML code snippet to the browser running on the network device to verify whether JavaScript is enabled or disabled locally at the network device.

5. The network device of claim 1, wherein the confidential web page comprises a log in page.

6. The network device of claim 1, wherein a second request for a second confidential web page is detected, and bypassing JavaScript enablement checks, within a predetermined period of time.

7. A computer-implemented method in application firewall device on an enterprise network that connects with a plurality of stations over a Wi-Fi network for data transfers, for detecting security breaches from web-based applications through JavaScript security, the method comprising the steps of:
detecting a request for a confidential web page on a specific network device, and in response, transmitting an HTML code snippet to a browser running on the network device to determine whether JavaScript is enabled or disabled locally at the network device; and
responsive to detecting that JavaScript has been locally disabled, restricting subsequent communication by the specific network device,
wherein the application firewall requires enabling of JavaScript to continue to the confidential web page, and responsive to detecting that JavaScript has not been disabled, allowing the request for the confidential web page to proceed.

8. A non-transitory computer-readable media in an network device on an enterprise network that connects with a plurality of stations over a Wi-Fi network for data transfers, when executed by a processor, for an artificial intelligence model-based data delivery for low battery stations co-existing with high-bandwidth stations within the plurality of stations, the method comprising the steps of:
detecting a request for a confidential web page on a specific network device, and in response, transmitting an HTML code snippet to a browser running on the network device to determine whether JavaScript is enabled or disabled locally at the network device; and
responsive to detecting that JavaScript has been locally disabled, restricting subsequent communication by the specific network device,
wherein the application firewall requires enabling of JavaScript to continue to the confidential web page, and responsive to detecting that JavaScript has not been disabled, allowing the request for the confidential web page to proceed.
